(19) United States
(12) Patent Application Publication
(10) Pub. No.: US 2015/0158126 A1
(43) Pub. Date: Jun. 11, 2015

(54) NICKEL-BASED BRAZING FOIL, METHOD FOR PRODUCING A BRAZING FOIL, OBJECT WITH A BRAZING SEAM AND BRAZING METHOD

(71) Applicants: Thomas Hartmann, Altenstadt (DE); Dieter Nützel, Shanghai PRC (CN); Alberto Bracchi, Hanau (DE)

(72) Inventors: Thomas Hartmann, Altenstadt (DE); Dieter Nützel, Shanghai PRC (CN); Alberto Bracchi, Hanau (DE)

(21) Appl. No.: 14/004,468

(22) PCT Filed: Mar. 8, 2012
(86) PCT No.: PCT/IB12/51082

§ 371 Date: Oct. 15, 2013

(30) Foreign Application Priority Data
Mar. 11, 2011 (DE) 10 2011 001 240.0

(51) Int. Cl. B23K 35/30; C22C 1/00; C22C 45/04; B23K 35/02; B23K 1/00

(52) U.S. Cl. CPC B23K 35/304; B23K 35/0233; B23K 1/0012; B23K 1/0008; C22C 45/04; C22C 1/002

(57) ABSTRACT

An amorphous, ductile brazing foil which substantially consists of Ni_{Bal}CrₐB_{b},P_{c}Si_{d}, wherein 21 atomic %≦a≦28 atomic %; 0.5 atomic %≦b≦7 atomic %; 4 atomic %≦c≦12 atomic %; 2 atomic %≦d≦10 atomic %; incidental impurities≦1.0% by weight; balance Ni, wherein a/c≧2, is provided.

### BACKGROUND

1. Field

The invention relates to an nickel-based brazing foil, a method for producing a brazing foil, an object with a brazing seam and a method for brazing two or more components.

2. Description of Related Art

Soldering is a method for joining components with the aid of a molten filler material, which is described as a solder. The melting temperature of the solder is lower than that of the base materials to be joined. The base materials may be metallic or ceramic.

A characteristic of the solder is its low melting range, i.e. the range between the solidus and the liquidus temperature, and the resulting processing temperature, which is typically 10° C. to 50° C. above the liquidus temperature. Depending on the processing temperature of the solder, a distinction is made between soft soldering and brazing. While soft solders are processed at temperatures below 450° C., brazing alloys are processed at temperatures above 450° C.

DE 10 2007 049 508 A1 discloses nickel-based brazing foils which can be produced in the form of ductile foils. These ductile brazing foils are produced in a rapid solidification process and are at least partially amorphous. The sum of the metalloids Si, B and P is chosen such that long foils can be produced with few geometrical fluctuations along the length of the foil. This improves the reliability of the brazing seams produced with these materials and reduces production costs.

Brazing alloys are used in applications where a high mechanical strength of the brazing seam or joint between the components and/or a high mechanical strength of the brazing seam at elevated operating temperatures are/is required. In some applications, for example in exhaust gas recirculation coolers for internal combustion engines, the joints come into contact with corrosive media.

Further improvement of the reliability of joints produced with brazing foils, combined with a high mechanical load-carrying capacity and resistance to corrosive media, is therefore desirable.

### SUMMARY

An object is therefore to provide a nickel-based brazing foil with which a joint can be produced which is more reliable when used in applications in which the joint is subjected to high mechanical loading and a corrosive medium.

This problem is solved by the subject matter of the independent claims. Advantageous further developments form the subject matter of the respective dependent claims.

According to the invention, an amorphous, ductile nickel-based brazing foil is provided with a composition consisting essentially of Ni_{Bal}CrₐB_{b},P_{c}Si_{d}, with 21 atomic %≦a≦28 atomic %; 0.5 atomic %≦b≦7 atomic %; 4 atomic %≦c≦12 atomic %; 2 atomic %≦d≦10 atomic %; incidental impurities≦1.0% by weight; balance Ni, wherein a/c≧2.

The invention further specifies an alternative amorphous, ductile nickel-based brazing foil with a composition which includes or can include additional elements. This alternative composition consists essentially of Ni_{Bal}CrₐB_{b},P_{c}Si_{d}MoₑX_{f}Y_{g}, wherein 21 atomic %≦a≦28 atomic %; 0.5 atomic %≦b≦7 atomic %; 4 atomic %≦c≦12 atomic %; 2 atomic %≦d≦10 atomic %; 0 atomic %≦e≦5 atomic %; 0 atomic %≦f≦5 atomic %; 0 atomic %≦g≦20 atomic %; incidental impurities≦1.0% by weight; balance Ni, wherein X is one or more of the elements Nb, Ta, W, Cu, C or Mn and Y is one or both of the elements Fe and Co. As in the first brazing foil, the ratio between chromium content and phosphorus content is at least 2, i.e. a/c≧2.

The brazing foils of both compositions have a chromium content of more than 21 atomic % to 28 atomic %. They further contain the elements P, B and Si as glass-forming elements in the above ranges, the lower limit of the silicon content being 2 atomic %, the higher limit of the phosphorus content being 12 atomic % and the boron content lying in the range between 0.5 atomic % and 7 atomic %. The ratio between chromium content and phosphorus content is 2 or higher.

These features of the composition, i.e. the chromium content, the content of glass-forming elements and the ratio between chromium content and phosphorus content, provide a brazing foil, with which a joint having a high mechanical strength and a high corrosion resistance can be produced. In compositions outside the above composition range, mechanical strength and corrosion resistance run against one another. In other words, the joints have either a high mechanical strength and a low corrosion resistance or a low mechanical strength and a high corrosion resistance.

In contrast, the invention provides a brazing foil with which a joint can be produced with combines a high mechanical strength with a high corrosion resistance.

As mentioned above, the brazing foils of both alternative compositions have a minimum chromium content of more than 21 atomic %. The upper limit of the chromium content is 28 atomic %. This chromium content provides a brazing foil having an improved corrosion resistance.

The reduction of emission values in automotive engineering is resulting in an increased demand for corrosion-resistant brazed joints of stainless steel, e.g. DIN EN 1.4404 or 1.4539, in sulphur-, nitrate- or chloride-containing media. The brazing foils according to the invention can be used in applications which involve corrosive media.

In applications which require a very good corrosion resistance of the components, such as EGR coolers (exhaust gas recirculation coolers) for internal combustion engines in the automotive industry, coarse grain formation is undesirable, because it reduces not only the mechanical properties, but also the corrosion resistance of the components. For this reason, it is further desirable to have a brazing temperature below 1100° C. in order to avoid such coarse grain formation. A liquidus temperature of the brazing foil of less than 1100° C. is therefore advantageous for these applications.

The brazing foils can contain incidental impurities amounting to up to 1 percent by weight. In practical applications, impurities are measured in percent by weight, and this unit is therefore used for impurities. In principle, impurities can include any elements which are not explicitly listed in the above compositions. Impurities which are frequently measured in brazing foils are Al, Ti, Zr, Cd, Se and S.

In further embodiments, the lower limit of the chromium content is higher, for example 21.5 atomic %, 22 atomic % or 23 atomic %. A slightly higher chromium content can further increase the corrosion resistance if the a/c ratio is kept above 2. Suitable chromium contents are 21.5 atomic %≦a≦28 atomic %, 22 atomic %≦a≦28 atomic % and 23 atomic %≦a≦27 atomic %.

In further embodiments, the ratios between the three different glass-forming elements Si, B and P are further preselected to further improve the length of the foil and/or the thickness fluctuations along the length of the foil. The glass-forming elements are also referred to as metalloids.

A phosphorus content c in atomic % higher than the boron content b in atomic %, which is higher than the phosphorus content c in atomic % divided by 15, i.e. c>b>c/15, and a total of glass-forming elements of 14 atomic %≦(b+c+d)≦20 atomic % can be used for this purpose.

The sum of these metalloids Si, B and P and the relationship between the P content and the B content of the brazing foil according to the invention provide a nickel-based brazing foil which can be produced as an at least partially amorphous ductile foil in great lengths up to more than 5 km and with few geometrical fluctuations along the length of the foil.

Owing to the increased length of the foil, production costs can be reduced. In addition, the reliability of the seams produced with the brazing foil is enhanced, because the foil has a uniform geometry.

In one embodiment, the brazing foil is at least 50% amorphous, preferably at least 80% amorphous.

In further embodiments, the sum total of glass-forming elements is 14 atomic %≦(b+c+d)≦18 atomic %. The content of the individual glass-forming elements may vary as desired within the above ranges, as long as the sum total remains within the above limits.

The content of the individual glass-forming elements can further be determined as follows: a B content of 1.5 atomic %≦b≦5.0 atomic % and/or a P content of 9 atomic %≦c≦11 atomic % and/or an Si content of 2.5 atomic %≦d≦4.5 atomic %.

In the second composition, the brazing foil can comprise further elements. In one embodiment, only up to 5 atomic % molybdenum are present in addition to Ni, Cr, B, P and Si. If the brazing foil contains one or more of the further elements Nb, Ta, W, Cu, C, Mn, Y, Fe or Co, the upper limit can be restricted as follows: 0 atomic %≦f≦3 atomic %; 0 atomic %≦g≦15 atomic %

The further processing of brazing foils typically involves slitting, cross-cutting, continuous etching, stamping or laminating. These further processing operations rely on the provision of very long foils having a stable geometry, if the requirements of economy are to be satisfied. This is possible with the brazing foil according to the invention.

Among other aspects, applications for amorphous brazing foils include the wrapping of the foil around a long cooling tube for joining it to a continuous helical cooling fin arranged on the circumference in a continuous process. These tubes, which may be up to 30 m long, are for example used as cooling tubes in steam generators.

For industrial applications like this, it is desirable if continuous foils with a length of more than 100 m and having a stable foil geometry are provided in order to allow such long tubes to be covered with a continuous, stable solder layer. In industrial assembly processes, too, it is generally desirable and/or required to use long foils in order to avoid uneconomically frequent machine stoppages in the automatic assembly machinery.

These requirements can likewise be met with the brazing foil according to the invention.

The brazing foils can have a thickness D of 15 μm≦D≦60 μm. They can further have a width B of 0.5 mm≦B≦300 mm or a width of 30 mm≦B≦150 mm. The brazing foils according to the invention can therefore be produced in dimensions which are suitable for a multitude of applications.

The brazing foil is provided in the form of a strip which can be cut in order to produce a plurality of smaller foils of the desired size and/or the desired external contour. The brazing foil according to the invention can be produced in lengths of several thousand metres. This offers the advantage that production costs can be reduced, because the quantity of brazing foil which is characterised by minimal geometric fluctuations and can be produced in a single casting operation is increased.

The brazing foil can further be produced reliably with low thickness fluctuations. In further embodiments, the thickness of the brazing foil fluctuates by less than 20% over a length of 100 m, by less than 25% over a length of 200 m and by less than 20% over a length of 5000 m. In further embodiments, the thickness of the foil fluctuates by less than 15 μm over a length of 100 m.

This uniform geometry is advantageous, because the brazing seams produced from the foil are reliable, so that an object having such a brazing seam does not fail at the joint between the parts concerned. Thickness fluctuations can lead to defects in the brazing seam and to an unreliable joint. This problem can be avoided, because the brazing foils according to the invention have low thickness fluctuations.

In further embodiments, each of the brazing foils has a liquidus temperature between 980° C. and 1100° C. This is desirable in many industrial brazing processes, in particular when joining stainless steel base materials, because the maximum brazing temperature for these base materials is limited to approximately 1200° C. As a rule, a brazing temperature as low as possible is aimed at, because from a temperature of 1000° C. an undesirable coarse grain formation of the base material occurs. This undesirable coarse grain formation results in a reduction of the mechanical strength of the base material, which is critical in many technological applications, for example in heat exchangers.

An object comprising a first component and a second component is also provided by the present invention. The first component is permanently joined to the second component by a brazing seam produced with a brazing foil according to any of the preceding embodiments. The object therefore has a brazing seam produced by means of a brazing foil according to the invention.

An object comprising a first component and a second component, wherein the first component is permanently joined to the second component by a brazing seam, is also provided. The brazing seam comprises Ni, Cr, Si, P and B, a matrix of mixed crystals and primary eutectic phases. The eutectic phases have an average composition of approximately Ni₃Cr₂P₂ and are arranged as inclusions in the matrix. The term “approximately” in this context means that the actual composition can deviate from this stoichiometric formula and can therefore not be specified precisely.

The brazing seam of the object has a microstructure which enhances the mechanical strength of the joint between the first component and the second component. This improved mechanical strength is achievable because the matrix of mixed crystals is ductile. The eutectic phases, on the other hand, are more brittle. These brittle eutectic phases are distributed as inclusions in the ductile matrix. The brazing seam does therefore not contain any continuous seam of brittle eutectic phases, where cracks can propagate unimpeded. On the contrary, the ductile matrix can sampsuch mechanical loads.

The matrix can have a sponge-like structure, with the eutectic phases being located in the cavities of the matrix. In one embodiment, the matrix extends continuously from the first component to the second component. This prevents the possibility that the brittle eutectic phases might form a continuous seam between the two components, which could tear under mechanical load.

The object may be an exhaust gas recirculation cooler, for example for an internal combustion engine of a motor vehicle, or a heat exchanger.

In one embodiment, the first component and the second component consist of a stainless steel. The stainless steel may for example be an austenitic stainless steel or have a ferritic or mixed structure. Alternatively, the components can be made of an Ni alloy or a Co alloy.

The brazing seam placed between the two components can have a thickness of more than 15 μm.

Methods for brazing two or more components are also provided. In one method, a brazing foil according to any of the preceding embodiments is introduced between two or more components to be joined. The components to be joined have a higher melting temperature than the brazing foil. The brazing composite is heated to a brazing temperature above the liquidus temperature of the brazing alloy and below the melting temperature of the two components. The brazing composite is then cooled while forming a brazed joint between the components to be joined.

The components to be joined may be parts of a heat exchanger or an exhaust gas recirculation cooler or an oil cooler, or components of a heat exchanger or an exhaust gas recirculation cooler or an oil cooler.

The brazing temperature to which the brazing composite is heated can lie between 1050° C. and 1200° C., preferably between 1080° C. and 1150° C.

In one embodiment, the brazing composite is heated to a brazing temperature above the liquidus temperature of the brazing foil in a protective gas atmosphere. This simplifies the brazing process, because the use of a vacuum furnace can be avoided. In a further embodiment, the brazing composite is heated to a brazing temperature above the liquidus temperature of the brazing foil in a continuous furnace. This method is simplified further if this method can be carried out in a protective gas atmosphere. The use of a continuous furnace offers the advantage that the brazing process is continuous. This enhances the efficiency of the method.

A method for producing an amorphous ductile brazing foil is also provided. In a first embodiment, a melt consisting of Ni_{Bal}CrₐB_{b},P_{c}Si_{d}, with 21 atomic %≦a≦28 atomic %; 0.5 atomic %≦b≦7 atomic %; 4 atomic %≦c≦12 atomic %; 2 atomic %≦d≦10 atomic %; incidental impurities≦1.0% by weight; balance Ni, wherein a/c≧2, or of Ni_{Bal}CrₐB_{b},P_{c}Si_{d}MoₑX_{f}Y_{g}, with 21 atomic %≦a≦28 atomic %; 0.5 atomic %≦b≦7 atomic %; 4 atomic %≦c≦12 atomic %; 2 atomic %≦d≦10 atomic %; 0 atomic %≦e≦5 atomic %; 0 atomic %≦f≦5 atomic %; 0 atomic %≦g≦20 atomic %; incidental impurities≦1.0 atomic %; balance Ni, wherein X is one or more of the elements Nb, Ta, W, Cu, C or Mn and Y is one or both of the elements Fe and Co and a/c≧2, is used. An amorphous ductile brazing foil is produced by the rapid solidification of the melt on a moving cooling surface with a cooling rate of more than 10⁴° C./s, for example approximately 10⁵° C./s.

### BRIEF DESCRIPTION OF DRAWINGS

The invention is explained in greater detail below with reference to the following embodiments, drawings and tables.

FIG. 1 is a schematic diagram of brazing seam properties of comparison brazing foils as a function of brazing temperature,

FIG. 2 is a schematic diagram of brazing seam properties of brazing foils according to the invention as a function of brazing temperature,

FIG. 3 is a schematic representation of the production of brazed samples for corrosion tests,

FIG. 4 is a metallographic micrograph of brazed stainless steel samples produced with a comparison brazing foil of the composition Ni—Cr21-P13.5-Si0.9-B2.4 stored in synthetic exhaust gas condensate for 1000 h,

FIG. 5 is a metallographic micrograph of brazed stainless steel samples produced with a brazing foil according to the invention of the composition Ni—Cr25-Mo1.5-P10-Si4-B2 stored in synthetic exhaust gas condensate for 1000 h,

FIG. 6 is a schematic representation of a comparison brazing seam morphology, and

FIG. 7 is a schematic representation of a brazing seam morphology according to the invention.

### DETAILED DESCRIPTION OF SPECIFIC EMBODIMENTS

In the description below, the following tables are referred to:
Table 1a illustrates the corrosive loss of mass of comparison brazed samples which were brazed with a comparison brazing foil at various temperatures,
Table 1b illustrates mechanical properties of the comparison brazed samples which were brazed with the comparison brazing foil at various temperatures,
Table 2a illustrates the corrosive loss of mass of comparison brazed samples which were brazed with a comparison brazing foil at various temperatures,
Table 2b illustrates mechanical properties of the comparison brazed samples which were brazed with the comparison brazing foil at various temperatures,
Table 3a illustrates the corrosive loss of mass of brazed samples according to the invention which were brazed with a brazing foil according to the invention at various temperatures,
Table 3a illustrates mechanical properties of the brazed samples according to the invention which were brazed with a brazing foil according to the invention at various temperatures, and
Table 4 illustrates the composition of comparison brazing foils and brazing foils according to the invention.

An amorphous ductile brazing foil having a composition substantially consisting of Ni_{Bal}CrₐB_{b},P_{c}Si_{d}, with 21 atomic %≦a≦28 atomic %; 0.5 atomic %≦b≦7 atomic %; 4 atomic %≦c≦12 atomic %; 2 atomic %≦d≦10 atomic %; incidental impurities≦1.0 atomic %; balance Ni, wherein a/c≧2, is provided.

This brazing foil is produced using a rapid solidification technology, such as the so-called “melt spinning” process, in the form of a long, ductile and at least partially amorphous strip. The strip can have a length of more than 5 km.

In a further embodiment, an alternative amorphous ductile brazing foil having a composition which does or may include additional elements is provided. This alternative composition consists substantially of Ni_{Bal}CrₐB_{b},P_{c}Si_{d}MoₑX_{f}Y_{g}, with 21 atomic %≦a≦28 atomic %; 0.5 atomic %≦b≦7 atomic %; 4 atomic %≦c≦12 atomic %; 2 atomic %≦d≦10 atomic %; 0 atomic %≦e≦5 atomic %; 0 atomic %≦f≦5 atomic %; 0 atomic %≦g≦20 atomic %; incidental impurities≦1.0 atomic %; balance Ni, wherein X is one or more of the elements Nb, Ta, W, Cu, C or Mn and Y is one or both of the elements Fe and Co and a/c≧2.

These two brazing foils have a composition which makes it possible to produce a brazing seam produced with the brazing foil comprising a good tensile strength combined with a good corrosion resistance, even at increasing brazing temperature. As a result, an object having two or more components which are joined together with this brazing foil is more reliable in operation, in particular when used in applications in which the brazing seam is subjected to high mechanical loads and to a corrosive medium.

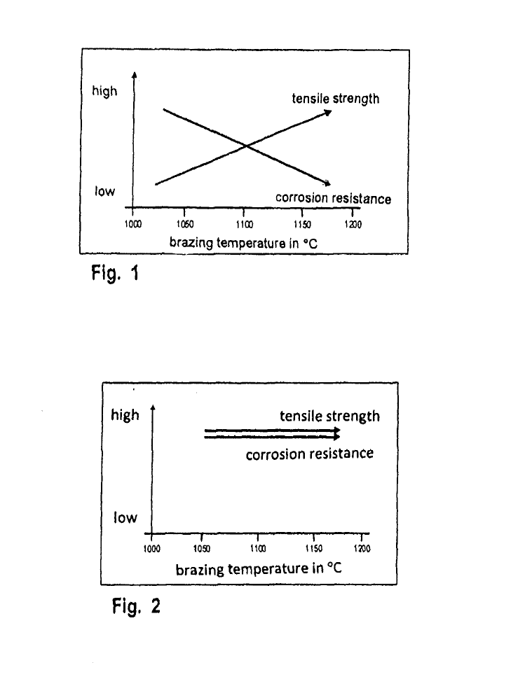

In contrast, brazing foils which have a composition outside the above ranges exhibit either a high tensile strength or a good corrosion resistance. This difference in the properties of the brazing seams is illustrated schematically in FIGS. 1 and 2.

FIG. 1 is a schematic representation of the tensile strength and the corrosion resistance of comparison brazing foils based on Ni—Cr—P—(Si, B), such as Ni 710, as a function of brazing temperature. As the brazing temperature increases, the tensile strength increases, while the corrosion resistance is reduced.

FIG. 2 is a schematic representation of the brazing seam properties tensile strength and corrosion resistance of brazing foils according to the invention as a function of brazing temperature. The brazing foils according to the invention have a good tensile strength and a good corrosion resistance, and the brazing temperature has virtually no influence on these properties.

Specific embodiments and values of these brazing seam properties are described below.

For these embodiments, various Ni-based brazing alloys were first produced as amorphous foils, which were then used to braze samples used for corrosion and strength investigations.

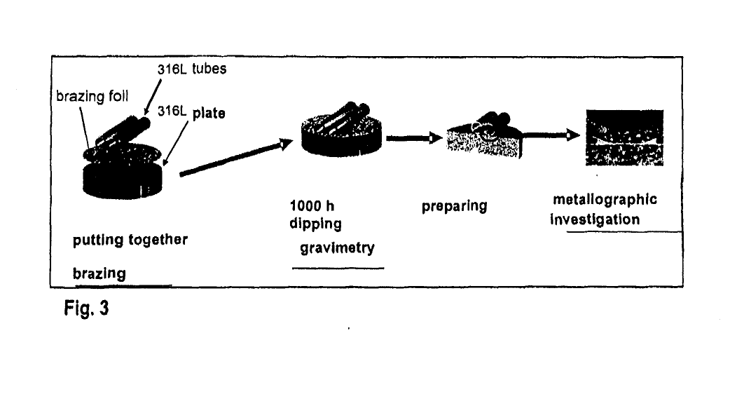

FIG. 3 is a schematic representation of brazed sample production for corrosion investigations. To start with, two tubes of stainless steel (316L 1.4404) were permanently joined to a plate of stainless steel (316L 1.4404) by brazing using a brazing foil in a vacuum. Before being stored in a corrosive medium, the samples were cut in order to give the corrosive medium as large an area of attack as possible in the region of the brazing seams.

The samples were stored in a synthetic corrosive medium with a pH-value<2 and SO₄²⁻NO₃⁻Cl⁻ ions at 70° C. for a total of 1000 h. Following this storage, the brazed stainless steel samples were prepared metallographically in order to evaluate the corrosion attack of the brazing seams.

To determine the mechanical properties of the brazed joint, the static tensile test was performed on a butt-brazed tensile sample. The brazing seam width was uniformly set to 50 μm.

The yield strength ratio (k_{H}) was used as a measure for the mechanical properties of a brazed component. The yield strength ratio is the quotient from yield strength (or yield point) and tensile strength, i.e.:

k_{H}=R_{p0.2}/Rₘ,

and it is a measure for the deformability of a material and indicates or gives an indication of the level of usable material strength.

When applied to brazed joints, values≧1 indicate a brittle behaviour of the brazed joint. They indicate that the strength values of the base material cannot be utilised and that a poor dynamic strength is to be expected. Values between 0.99 and 0.4 indicate brazed joints which completely exploit the technically relevant base material strengths and are capable of tolerating a minimum of plastic deformation.

Such a state is desirable, because a good dynamic strength can be expected from these brazed joints. If the tensile samples fail before reaching their yield point, the value reached theoretically by the base material—after suitable heat treatment—is used as calculating value for R_{p0.2}. Values below 0.4 reflect states in which the brazed sample has too low a yield point because the brazed joint is too soft. Such a state, however, is not expected in the case of nickel-based brazing alloys.

### Comparison Example 1

An Ni-based brazing alloy of the composition Ni—Cr21-P13.5-Si0.9-B2.4 (atomic %) is first produced using rapid solidification technology as amorphous brazing foil with a thickness of 50 μm. With this brazing foil, the samples were produced—as described above—for corrosion evaluation and strength resting.

TABLE 1a

| | | | | | Brazing parameters | | Loss of mass after |
|---|---|---|---|---|---|---|---|
| Composition in atomic % | | | | | Temperature | Time | 1000 h in corrosive |
| Ni | Cr | Si | B | P | [° C.] | [min] | medium [%] |
| Balance | 21 | 0.9 | 2.4 | 13.5 | 1000 | | 0.052 |
| | | | | | 1050 | 15 | 0.063 |
| | | | | | 1100 | | 0.081 |
| | | | | | 1150 | | 0.099 |

Table 1a illustrates the corrosive loss of mass of brazed samples of stainless steel 1.4404 which were brazed using the comparison brazing foil VZ2170 (Ni—Cr21-Si0.9-B2.4-P13.5 (atomic %) at various temperatures. The corrosive medium was a synthetic exhaust gas condensate.

Table 1a further illustrates the corrosive attack of the brazing seams in the form of loss of mass, which increases with brazing temperature. In corrosion-resistant joints, loss of mass values should not substantially exceed 0.05%.

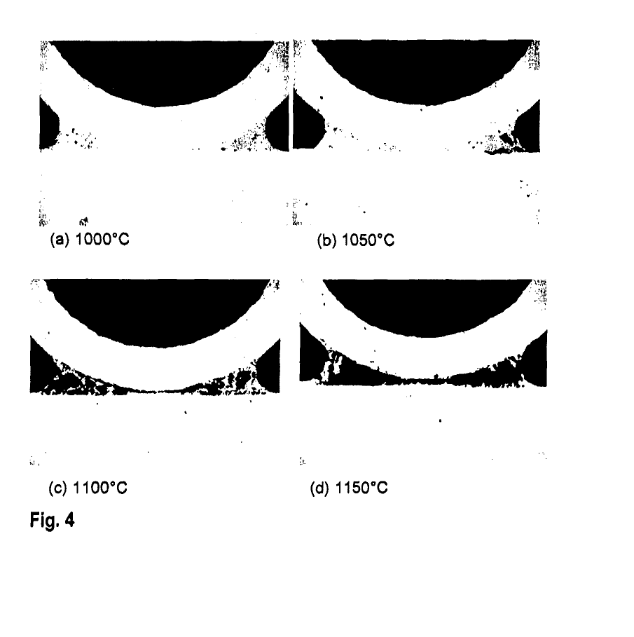

FIGS. 4a to 4d illustrate the metallographic specimens of brazing seams joined at various brazing temperatures. The corrosion of the brazing seam increases with the brazing temperature, as indicated in the specimens in the form of enlarged black areas between the tube and the plate. These black areas are dissolved points of the brazing seam, i.e. points which have corroded away.

It can be seen that the samples brazed at 1100° C. and 1150° C. in particular have experienced massive corrosion attack. Large areas of the brazing seam have been largely—at a brazing temperature of 1150° C. even completely—dissolved by the corrosive medium. There is no longer a mechanically stable and tight joint. At 1050° C., the brazed joint only exhibits local corrosion attack, and at 1000° C., no large-area corrosion attack is discernible. These results lead to the conclusion that a good corrosion resistance which ensures a stable and tight joint over the lifetime of the component can only be achieved with a brazing temperature below 1100° C.

TABLE 1b

| | | | | | Brazing | | | | |
|---|---|---|---|---|---|---|---|---|---|
| Composition | | | | | parameters | | Strength values | | |
| in atomic % | | | | | Tempera- | Time | R_{p0.2} | Rₘ | |
| Ni | Cr | Si | B | P | ture [° C.] | [min] | [N/mm²] | [N/mm²] | k_{H} |
| Balance | 21 | 0.9 | 2.4 | 13.5 | 1000 | | (245) | 90 | 2.72 |
| | | | | | 1050 | 30 | (240) | 212 | 1.13 |
| | | | | | 1100 | | 235 | 240 | 0.98 |
| | | | | | 1150 | | 229 | 236 | 0.97 |
| | | | | | 1150 | 60 | 199 | 204 | 0.98 |

Table 1b illustrates the strength values of butt-brazed tensile samples produced using the same brazing parameters as the corrosion samples shown in Table 1a. The brazing gap width is 50 μm.

It can be seen clearly that a yield strength ratio of <1 can only be achieved at brazing temperatures of at least 1100° C. Brazing temperatures below 1150° C. are therefore unsuitable for components which are subjected to high mechanical loads and which are joined using this comparison foil.

Comparison example 1 therefore demonstrates that this brazing foil is incapable of producing joints which combine optimum corrosion resistance with the best possible strength properties.

### Comparison Example 2

Comparison example 2 also illustrates how changes in the brazing temperature affect the performance of the brazing seam if the phosphorus content of the brazing alloy is too high and its chromium content is too low.

The standardised Ni-based brazing alloy Ni 710 of the composition Ni—Cr14.3-P17.1 (atomic %) is first produced using rapid solidification technology as amorphous brazing foil with a thickness of 50 μm. With this brazing foil, samples were produced as in Example 1 and subjected to the same tests.

Table 2a illustrates the corrosive loss of mass of brazed samples of stainless steel 1.4404 which were brazed using the comparison brazing foil Ni 710 (Ni—Cr14.3-P17.1 atomic %) at various temperatures. The corrosive medium was a synthetic exhaust gas condensate.

TABLE 2a

| | | | | | Brazing | | Loss of mass |
|---|---|---|---|---|---|---|---|
| | | | | | parameters | | after 1000 h |
| Composition in atomic % | | | | | Tempera- | Time | in corrosive |
| Ni | Cr | Si | B | P | ture [° C.] | [min] | medium [%] |
| Balance | 14.3 | — | <0.01 | 17.1 | 1000 | | 0.082 |
| | | | | | 1050 | 15 | 0.091 |
| | | | | | 1100 | | 0.152 |
| | | | | | 1150 | | 0.184 |

Table 2a illustrates the corrosive attack of the brazing seams in the form of loss of mass, which increases with brazing temperature. It can be seen that the samples brazed at 1100° C. and 1150° C. in particular have been subjected to massive corrosion attack, the values in part being substantially higher than those of Example 1. There is no longer a mechanically stable and tight joint.

TABLE 2b

| | | | | | Brazing | | | | |
|---|---|---|---|---|---|---|---|---|---|
| | | | | | parameters | | Strength values | | |
| | | | | | Temper- | | R_{p0.2} | Rₘ | |
| Composition in atomic % | | | | | ature | Time | [N/ | N/ | |
| Ni | Cr | Si | B | P | [° C.] | [min] | mm²] | mm²] | k_{H} |
| Balance | 14.3 | — | <0.01 | 17.1 | 1000 | | (245) | 131 | 1.87 |
| | | | | | 1050 | 30 | (240) | 145 | 1.66 |
| | | | | | 1100 | | (235) | 193 | 1.22 |
| | | | | | 1150 | | (230) | 228 | 1.01 |

Table 2b illustrates the strength properties of these butt-brazed samples of stainless steel 1.4404 which were brazed using the comparison brazing foil Ni 710 (Ni—Cr14.3-P17.1 atomic %) at various temperatures. The brazing seam width is 50 μm.

When looking at the tensile strength values summarized in Table 2b, one can see that even at high brazing temperatures of 1150° C., a yield strength ratio of <1 was not reached.

Comparison example 2 illustrates that it is impossible to produce stainless steel brazed joints which combine optimum corrosion resistance with the best possible strength properties with this brazing foil.

The comparison examples demonstrate that the properties of brazed joints on stainless steels which are produced using the comparison amorphous phosphorus-containing nickel/chromium brazing foils react strongly to changes in brazing temperature. Owing to this type of behaviour, either the corrosion resistance or the strength of these brazed joints is affected, as shown schematically in FIG. 1.

### Embodiment According to the Invention

A brazing alloy of the composition Ni—Cr25-Mo1.5-P10-Si4-B2 (atomic %) is first produced using rapid solidification technology as amorphous brazing foil with a thickness of 50 μm.

From this brazing foil, samples are produced as in the case of comparison examples 1 and 2, and these samples were subjected to the same tests. It was, however, impossible to produce comparison samples for the brazing conditions at 1000° C. and 1050° C., because the liquidus temperature of the alloy is 1060° C., so that it could not melt completely.

TABLE 3a

| | | | | | | Brazing parameters | | Loss of mass after |
|---|---|---|---|---|---|---|---|---|
| Composition in atomic % | | | | | | Temperature | Time | 1000 h in corrosive |
| Ni | Cr | Mo | Si | B | P | [° C.] | [min] | medium [%] |
| Balance | 25 | 1.5 | 4 | 2 | 10 | 1080 | | 0.028 |
| | | | | | | 1100 | 15 | 0.032 |
| | | | | | | 1150 | | 0.037 |
| | | | | | | 1080 | 60 | 0.032 |

Table 3a illustrates the corrosive loss of mass of brazed samples of stainless steel 1.4404 which were brazed using the brazing foil according to the invention Ni—Cr25-Mo1.5-Si4-B2-P10 (atomic %) at various temperatures. The corrosive medium was a synthetic exhaust gas condensate.

Table 3a illustrates that there is no significant change in corrosive loss of mass with increasing brazing temperature. Even at a brazing temperature of 1150° C., loss of mass is significantly less than that of the samples from comparison examples 1 or comparison example 2.

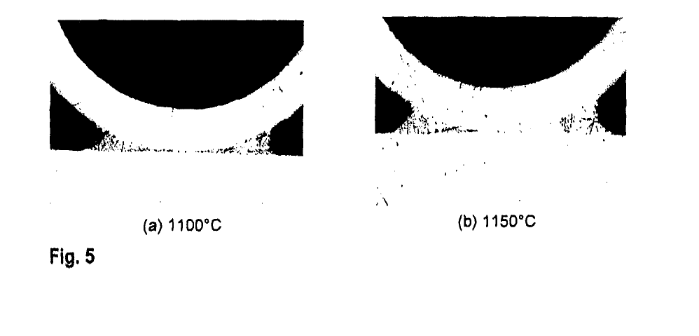

FIGS. 5a and 5b illustrate the metallographic polished cross-sections of brazing seams produced at various brazing temperatures. The specimens were produced in a vacuum at various temperatures using a brazing foil of the composition according to the invention Ni—Cr25-Mo1.5-P10-Si4-B2 (atomic %) and then aged for 1000 h in a synthetic exhaust gas condensate. The specimens were brazed at 1100° C. and 1150° C. These figures illustrate that, even when using these higher brazing temperatures, the brazing seams do not show any indication of corrosion as represented by dissolved-out material, for example. There is no significant corrosion attack to be observed.

TABLE 3b

| | | | | | | Brazing parameters | | Strength values | | |
|---|---|---|---|---|---|---|---|---|---|---|
| | | | | | | Temper- | | R_{p0.2} | Rₘ | |
| Composition in atomic % | | | | | | ature | Time | [N/ | [N/ | |
| Ni | Cr | Mo | Si | B | P | [° C.] | [min] | mm²] | mm²] | k_{H} |
| Balance | 25 | 1.5 | 4 | 2 | 10 | 1080 | 15 | 234 | 239 | 0.98 |
| | | | | | | 1100 | 15 | 235 | 240 | 0.98 |
| | | | | | | 1150 | 60 | 202 | 214 | 0.94 |

Table 3b illustrates the strength properties of butt-brazed samples of stainless steel 1.4404 which were brazed using the using the brazing foil according to the invention Ni—Cr25-Mo1.5-Si4-B2-P10 (atomic %) at various temperatures. The brazing seam width is 50 μm.

The tensile strength tests, which are summarised in Table 3b, show under all of the brazing parameters tested yield strength ratios of less than 1, irrespective of the brazing temperature chosen. There is therefore a mechanically stable and tight joint which can resist a strong corrosion attack. As FIG. 5 also illustrates, these properties are moreover unaffected by the joining temperature.

The embodiment according to the invention therefore demonstrates that, with the brazing foil according to the invention, joints which combine good corrosion resistance with high strength can be made with stainless steel as base material.

Known phosphorus-containing nickel-based brazing foils such as Ni 710 or VZ2170 (comparison alloys 1 and 2) are used for joining corrosion-resistant stainless steels and represent commercially available amorphous Ni—Cr—P-based brazing foils. The required brazing temperature lies in a range between 980° C. and 1200° C., and the brazing times lie in a range between 3 and 60 minutes. The best corrosion resistance of the said brazed joints is obtained if the brazing seam has only a low degree of diffusion, i.e. the temperature is chosen as low as possible and the brazing times as short as possible. The opposite applies to the strength values of the said brazed joints. At a low degree of diffusion, the strength properties of the brazing seams are inadequate, being significantly lower than the yield point of the base material. At a higher degree of diffusion—resulting from higher brazing temperatures and/or longer brazing times—the strength of the joints improves. At the same time, however, their corrosion resistance is reduced (see FIG. 1).

Using the comparison foils, it is therefore not possible to combine good strength properties with good corrosion resistance. In addition, the strong dependence of the properties of the brazing seam on heat treatment parameters is basically a disadvantage, because it requires tight manufacturing tolerances in the brazing processes.

In contrast, the brazing foils according to the invention suffer neither the disadvantage of either good mechanical strength or good corrosion resistance, nor the disadvantage of the strong dependence of mechanical strength and corrosion resistance on brazing temperature. Brazing seams produced with the brazing foils according to the invention combine good corrosion resistance values with good strength values, these properties being independent of brazing temperature, as shown schematically in FIG. 2. The use of such brazing foils offers greater freedom in the choice of the base materials and the furnace type, because stable and predictable brazing seam properties are obtained irrespective of the chosen brazing parameters. Furthermore, the typical fluctuations to be expected in the production sequence and in the component tolerances no longer affect the quality of the brazed joint.

These optimised corrosion and strength properties are also important if brazing foils are used in a component in combination with pastes such as Ni 655 or FP-613. For these alloys which, owing to their composition, cannot be produced as amorphous foils, no equivalent in foil form has been found so far. Compositions built up in accordance with the present invention allow the production of amorphous foils having properties comparable to those of the above standard alloys. The foils should be suitable for processing at temperatures significantly above 1050° C., because it may be possible to combine them with pastes, depending on the complexity of the component to be joined. These pastes are typically processed at a temperature of 1100° C.

The corrosion resistance of the brazed object is—irrespective of brazing temperature—very good in aggressive media, in particular in oxidising and reducing acids with further aggressive ions, such as sulphate, nitrate and chloride ions.

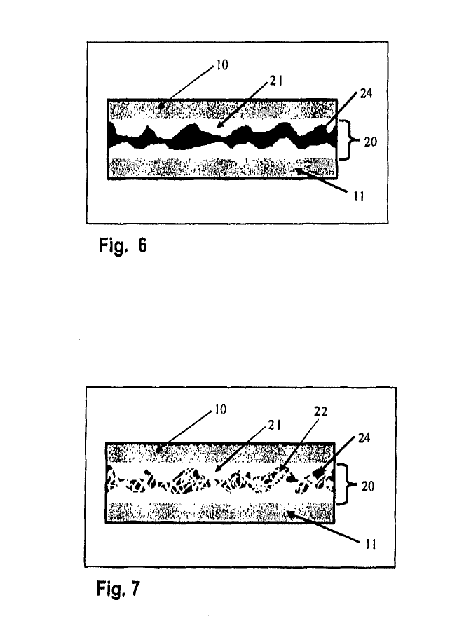

The composition of the brazing foil according to the invention provides for a suitable structure within the brazing seam, which results in improved strength properties. FIGS. 6 and 7 illustrate a comparison.

FIG. 6 is a schematic representation of a brazing seam morphology which is formed with a comparison brazing foil of Ni 710.

The brazing seam 20 extends between a first component 10 and a second component 11 and has continuous primary eutectic brittle phases 24 in the middle of the brazing seam as well as mixed crystal phases 21 located between the components 10, 11 and the brittle phases 24. As the primary eutectic phases are very brittle, cracks in this continuous brittle layer can spread from the primary eutectic phases through the entire brazing seam. This can result in a complete tearing of the brazed joint under only low mechanical loads.

FIG. 7 is a schematic representation of an advantageous brazing seam morphology as generated in the brazing alloys according to the invention. This brazing seam morphology is characterised in that the ductile mixed crystal phases 21, which form primarily at the boundary towards the base material 10, 11 at the start of the solidification process, are not separated from the other component by a dense, continuous band of primary eutectic phases 24 as shown in FIG. 6, but the ductile mixed crystal phases have a net-like structure which extends between the two components 10 and 11. The primary eutectic brittle phases are located as inclusions in the cavities of the net-like structure of the ductile mixed crystal phases.

To optimise the strength properties, the composition of the brazing alloy and the brazing cycle can be chosen such that, even in the middle of the brazing seam between the two components to be joined, the matrix phases are formed in such a way that—as shown in FIG. 7—the primary eutectic phases are bridged thereby. This results there in a sponge-like structure of matrix phases, in the cavities of which the eutectic accumulates. After solidification, the ductile matrix phases, which extend through the entire brazing seam, prevent an unimpeded crack propagation in the brittle eutectic phases, thereby enhancing the strength of the brazed joint.

The brazing cycle required for this can include brazing temperatures between 1050° C. and 1200° C. with dwell times of at least 10 minutes in order to obtain the required degree of diffusion of the brazing seam. Moreover, for an unimpeded formation of the advantageous brazing seam morphology, the cooling rate after the brazing cycle should not be higher than 150° C./min. In parallel, the composition of the brazing foil according to the invention ensures that a very good corrosion resistance of the brazed joint is obtained.

When joined to stainless steel components, the brazing foil according to the invention combines a very good corrosion resistance with very good strength values. This being so, the brazing foils should fulfil the following criteria in order to meet the conditions explained above:

### Corrosion Resistance

Phosphorus-containing nickel brazing alloys based on Ni—Cr—P—(Si, B) form in the solidification process after brazing an eutectic phase having a composition which largely corresponds, for example, to (Ni, Fe)₃Cr₂P₂. The volume fraction of this primary eutectic phase is largely determined by the level of the phosphorus content in the brazing alloy. As large quantities of chromium are bound in the primary eutectic, there is a chromium depletion in the adjoining mixed crystals of the brazing seam, which makes these regions sensitive to corrosion attack.

It has been found that chromium contents up to 18%, which usually ensure a complete corrosion resistance in austenitic steels, are in these phosphorus-containing materials not sufficient for adequate corrosion resistance in some applications.

The comparison Ni—Cr—Si—P alloys and in particular the Ni—Cr—P—Si/B brazing foils produced using rapid solidification technology, which typically have a chromium content in the range of 20 atomic % and a phosphorus content of more than 12 atomic %, further exhibit a very strong dependence of the brazed component on the joining temperature. At joining temperatures in the range of 1100° C., the corrosion resistance of the comparison foils is already reduced so much that permanent dense and corrosion-resistant joints are no longer guaranteed and the premature failure of the brazed component has to be expected (see comparison example 1).

To solve these problems, the brazing foils according to the invention have a significantly reduced phosphorus content of less than 12%, whereby the volume fraction of the deposited primary eutectic in the brazing seam is noticeably reduced. The chromium content of the alloy according to the invention is furthermore at least twice as high as its phosphorus content, in order to ensure that even in the mixed crystals of the brazing seam there is enough chromium to ensure the corrosion resistance of these phases. Brazing foils according to the present invention have an improved corrosion resistance which is unaffected by the brazing temperature. This ensures that the component remains tight and corrosion-resistant over its whole period of use. The composition of the brazing foil according to the invention can for this purpose be designed such that
P≦12 atomic % (−4)
Cr>21 atomic % (−28)
atomic % Cr/atomic % P=≧2.

### Strength

Good strength properties of brazed joints produced with nickel-based alloys are in most cases obtained if the yield strength ratio (k_{H}) of butt-brazed tensile samples is <1. In addition, a minimum of elongation at fracture should be measured on the sample. The elongation at fracture (A) is a material characteristic which indicates the permanent elongation of the sample after its break relative to the length measured initially. The elongation at fracture therefore characterises the deformability of the material. In order to obtain good strength values, it is desirable for the brazed joint to have a minimum of elongation at fracture and a yield strength ratio<1.

As the yield strength of the base material is reduced by high brazing temperatures, it is desirable for the brazing foils according to the invention to have a correspondingly low brazing temperature range, which is preferably below 1150° C. In this way, the excessive damage of the base material by temperature effects in the brazing process can be avoided, because this would have an adverse effect on the strength of the joint.

Furthermore, a relationship was found between the phosphorus content of the brazing foil and the strength properties of the brazed component. To obtain permanently strong brazed joints with stainless steels which have a tensile strength above the yield strength of the base material, the phosphorus content of the brazing foil should not exceed 12 atomic %. The lower the phosphorus content, the better is the tensile strength.

The presence of silicon is required in order to set the total metalloid content of the brazing foil to a range of 14-18 atomic %; this is required for good glass forming characteristics, which are important for foil production. It was further found that silicon has a positive effect on the strength properties of the brazing seam. This being so, the silicon content is chosen as follows:
Si≧2 atomic % (−10%).

### Maximum Possible Thickness

For use in industrial joining processes, the thickness of the amorphous foils is chosen such that that they can be produced with a thickness up to 50 μm without having brittle areas which would affect the subsequent processing of the foils. High chromium contents of more than 18%, in particular, greatly reduce the glass formation tendency of such alloys, however, with the result that the foils form crystalline areas even at low strip thicknesses of less than 40 μm and therefore become brittle and can no longer be processed. In the foils according to the invention, however, foil thicknesses of more than 40 μm can be produced even at a chromium content of 28%.

To adjust the amorphous structure of the brazing foils, their composition can, in addition to the proportion of transition metals (e.g. Ni, Fe, Co, Cr or Mo), which typically amounts to 70 to 85 atomic %, contain a proportion of metalloids (e.g. P, B, Si, C or Sb) of 15 to 30 atomic %. To adjust the amorphous atom distribution of the brazing foil, the melt has to be solidified at a cooling rate of more than 10⁴° C./sec during the foil production process. When producing amorphous foils, the single roller method is typically chosen for this purpose, i.e. the melt is sprayed onto a rotating roller the material of which should have a thermal conductance of more than 100 W/mK.

The metalloids very often form deep eutectics with the transition metals and are largely responsible for the fact that the melting temperature of the Ni—Fe—Cr matrix can be adjusted from melting temperatures of around 1450° C. to temperatures<1200° C., preferably below 1100° C.

It has been found that the composition of the amorphous brazing foil according to the invention, which can be produced in strip thicknesses up to 50 μm and which contains more than 21% chromium, is chosen such that the sum of the glass-forming elements silicon, phosphorus, boron and carbon should lie within a narrow window of 14 to 18 atomic %, and that the chromium content of the alloy should not exceed 28%.
Si+P+C+B=14-18 atomic %
Chromium<28%

### Maximum Possible Length

When choosing the chemical composition of the foils, the possibility of producing them in great, virtually endless, lengths can also be taken into consideration, because this makes them suitable for continuous production processes. In this context, the following rule is applied:
atomic % P≧atomic % B≧atomic % P/15.

### Brazing Temperature

As brazing temperatures below 1150° C. are aimed at when joining stainless steel, the liquidus temperature of the brazing foil according to the invention should not be higher than 1130° C. An excessively low phosphorus content below 4% would have the result that, even when adding other melting point depressants such as silicon or boron to the alloy, the liquidus temperature of the alloy would be above 1130° C., so that this content cannot be chosen at too low a level.
P≧4%.

The demand for further reductions in the emission values generated in automotive engineering, in particular, places increasing demands on the strength and corrosion resistance of brazed stainless steel joints having a good resistance against sulphurous, nitrate- and chloride-containing media as laid down in e.g. DIN EN 1.4404 or 1.4539.

As a result of these steadily increasing demands, many amorphous nickel/chromium-based brazing foils, such as comparison examples 1 and 2, do no longer guarantee an adequate performance of the brazed joint. In terms of the materials used, the trend is therefore away from the classic alloy systems Ni—Cr—Si—B, Ni—Cr—Si and Ni—Cr—P towards modern alloy systems such as Ni—Cr—Si—P and Ni—Cr—Si—B—P, because these systems offer moderate melting points combined with good corrosion resistance and strengths of the brazing seam.

The amorphous comparison brazing foils based on Ni—Cr—P—Si—B, which are produced using rapid solidification technology and which typically have a chromium content of ≦21 atomic % and a phosphorus content above 12 atomic %, exhibit a strong dependence of the corrosion resistance and the strength of the component brazed therewith on joining temperature. It is, however, disadvantageous that these two properties react oppositely to changes in their joining temperature, which is illustrated in FIG. 1. At low joining temperatures, maximum corrosion resistance can be achieved, but this is combined with low strength; at high joining temperatures, the strength of the components improves, but their corrosion resistance is reduced markedly. This disadvantageous behaviour is exhibited by comparison examples 1 and 2.

TABLE 4

| | | | | | | | Sum | Max. | Max. | | Yield | Corrosive |
|---|---|---|---|---|---|---|---|---|---|---|---|---|
| | Ni | Cr | Si | P | B | Others | Si + P + | thickness | length | Cr/ | strength | loss of mass |
| Example | [at. %] | [at. %] | [at. %] | [at. %] | [at. %] | [at. %] | B + C | [μm] | [m] | P ≧ 2 | ratio k_{H}¹ | [%] |
| 1 (FP 613)* | Balance | 28.9 | 7.4 | 10 | <0.1 | | 17.4 | <20 | <30 | 2.89 | 0.98 | 0.0387 |
| 2 (Ni 655)* | Balance | 21.9 | 12 | 6.7 | <0.1 | | 18.7 | <30 (?) | <50 | 3.27 | 0.89 | — |
| 3 (Ni 710)* | Balance | 14.3 | — | 17.1 | <0.1 | | 17.1 | 50 | <50 | 0.84 | 1.22 | 0.1521 |
| 4 (VZ2170)* | Balance | 21 | 0.9 | 13.5 | 2.4 | | 16.8 | 80 | >5000 | 1.56 | 0.98 | 0.0812 |
| 5 | Balance | 25 | 4 | 10 | 2 | Mo 1.5 | 16 | 55 | >5000 | 2.5 | 0.94 | 0.0262 |
| 6 | Balance | 22 | 5.5 | 8.5 | 2 | | 16 | 60 | >5000 | 2.59 | 0.91 | 0.0677 |
| 7* | Balance | 20 | 8 | 5 | 5 | | 18 | 50 | >5000 | 4 | 0.87 | — |

*= comparison example

Table 4 summarises the composition of five comparison brazing foils and two brazing foils according to the invention. The maximum thickness and the maximum length of the amorphous ductile brazing foils produced using a rapid solidification technology are also listed in Table 4. Table 4 further contains the measured yield strength ratio and the measured corrosive loss of mass of brazing seams produced with the brazing foils.

Table 4 illustrates that only the two embodiments 5 and 6 according to the invention offer a yield strength ratio above 0.9 and a loss of mass below 0.07 percent and that only these can be produced in a length of more than 5000 m. These brazing foils can therefore be produced more cost-effectively and at the same time offer good mechanical strength and good corrosion resistance in objects having a joint produced from these brazing foils.

1. An amorphous, ductile Ni-based brazing foil having a composition consisting essentially of
Ni_{Bal}CrₐB_{b},P_{c}Si_{d},
wherein 21 atomic %≦a≦28 atomic %; 0.5 atomic %≦b≦7 atomic %; 4 atomic %≦c≦12 atomic %; 2 atomic %≦d≦10 atomic %; incidental impurities≦1.0% by weight; balance Ni, wherein a/c≧2.

2. An amorphous, ductile Ni-based brazing foil having a composition consisting essentially of
Ni_{Bal}CrₐB_{b},P_{c}Si_{d}MoₑX_{f}Y_{g},
wherein 21 atomic %≦a≦28 atomic %; 0.5 atomic %≦b≦7 atomic %; 4 atomic %≦c≦12 atomic %; 2 atomic %≦d≦10 atomic %; 0 atomic %≦e≦5 atomic %; 0 atomic %≦f≦5 atomic %; 0 atomic %≦g≦20 atomic %; incidental impurities≦1.0% by weight; balance Ni, wherein X is one or more of the elements Nb, Ta, W, Cu, C or Mn and Y is one or both of the elements Fe and Co, and wherein a/c≧2.

3. The amorphous, ductile brazing foil according to claim 1,
wherein
the content of Cr is such that 22 atomic %≦a≦28 atomic %.

4. The amorphous, ductile brazing foil according to claim 3,
wherein
the content of Cr is such that 23 atomic %≦a≦27 atomic %.

5. The amorphous, ductile brazing foil according to claim 1,
wherein
c>b>c/15 and 14 atomic %≦(b+c+d)≦20 atomic %.

6. The amorphous, ductile brazing foil according to claim 1,
wherein
0 atomic %≦f≦3 atomic %; 0 atomic %≦g≦15 atomic %.

7. The amorphous, ductile brazing foil according to claim 1,
wherein
14 atomic %≦(b+c+d)≦18 atomic %.

8. The amorphous, ductile brazing foil according to claim 1,
wherein
the content of B is such that 1.5 atomic %≦b≦5.0 atomic %.

9. The amorphous, ductile brazing foil according to claim 1,
wherein
the content of P is such that 9 atomic %≦c≦11 atomic %.

10. The amorphous, ductile brazing foil according to claim 1,
wherein the content of Si is such that 2.5 atomic %≦d≦4.5 atomic %.

11. The amorphous, ductile brazing foil according to claim 1,
wherein
the brazing foil is at least 80% amorphous.

12. The amorphous, ductile brazing foil according to claim 1,
comprising
an average thickness D of 15 μm≦D≦60 μm.

13. The amorphous, ductile brazing foil according to claim 1,
comprising
a width B of 0.5 mm≦B≦300 mm.

14. The amorphous, ductile brazing foil according to claim 13,
wherein
the width B is such that 30 mm≦B≦150 mm.

15. The amorphous, ductile brazing foil according to claim 1,
comprising
a thickness fluctuation relative to an average thickness of less than 25% over a length of 200 m and/or a thickness fluctuation relative to an average thickness of less than 20% over a length of 100 m and/or a thickness fluctuation relative to an average thickness of less than 20% over a length of 5000 m.

16. The amorphous, ductile brazing foil according to claim 1,
comprising
a thickness fluctuation relative to an average thickness of less than 15 μm over a length of 100 m.

17. The amorphous, ductile brazing foil according to claim 1,
comprising
a liquidus temperature between 980° C. and 1100° C.

18. An object comprising a first component and a second component, wherein the first component is permanently joined to the second component by means of a brazing seam produced with an amorphous, ductile brazing foil according to claim 1.

19. An object comprising a first component and a second component, wherein the first component is permanently joined to the second component by means of a brazing seam, the brazing seam comprising Ni, Cr, Si, P and B,
wherein
the brazing seam comprises a matrix of mixed crystals and primary eutectic phases with an average composition of approximately Ni₃Cr₂P₂, the eutectic phases being located in the matrix as inclusions.

20. The object according to claim 19,
wherein
the matrix has a sponge-like structure.

21. The object according to claim 19,
wherein
the matrix extends continuously from the first component to the second component.

22. The object according to claim 18,
wherein
the first component and the second component consist of a stainless steel.

23. The object according to claim 18,
wherein
the brazing seam has a thickness>15 μm.

24. The object according to claim 18,
wherein
the object is a heat exchanger or an exhaust gas recirculation cooler for an internal combustion engine, or a part thereof.

25. A method for producing an amorphous, ductile brazing foil, the method comprising:
producing a melt consisting of Ni_{Bal}CrₐB_{b},P_{c}Si_{d}, with 21 atomic %≦a≦28 atomic %; 0.5 atomic %≦b≦7 atomic %; 4 atomic %≦c≦12 atomic %; 2 atomic %≦d≦10 atomic %; incidental impurities≦1.0% by weight; balance Ni, wherein a/c≧2, or of Ni_{Bal}CrₐB_{b}, P_{c}Si_{d}MoₑX_{f}Y_{g}, with 21 atomic %≦a≦28 atomic %; 0.5 atomic %≦b≦7 atomic %; 4 atomic %≦c≦12 atomic %; 2 atomic %≦d≦10 atomic %; 0 atomic %≦e≦5 atomic %; 0 atomic %≦f≦5 atomic %; 0 atomic %≦g≦20 atomic %; incidental impurities≦1.0% by weight; balance Ni, wherein X is one or more of the elements Nb, Ta, W, Cu, C or Mn and Y is one or both of the elements Fe and Co, and wherein a/c≧2,
producing an amorphous, ductile brazing foil by the rapid solidification of the melt on a moving cooling surface at a cooling rate of more than 10⁴° C./sec.

26. A method for joining two or more components by adhesive force, the method comprising:
introducing a brazing foil according to claim 1 between two or more components to be joined, the components to be joined having a higher melting temperature than the brazing foil,
heating the brazing composite to a brazing temperature above the liquidus temperature of the brazing alloy,
cooling the brazing composite accompanied by the forming of a brazed joint between the components to be joined.

27. The method according to claim 26,
wherein
the brazing composite is heated to a brazing temperature between 1050° C. and 1200° C.

28. The method according to claim 26,
wherein
the components to be joined are parts of a heat exchanger or of an exhaust gas recirculation cooler or components thereof.

29. The method according to claim 26,
wherein
the heating of the brazing composite to a brazing temperature above the liquidus temperature of the brazing foil is carried out in a protective gas atmosphere.

30. The method according to claim 26,
wherein
the heating of the brazing composite to a brazing temperature above the liquidus temperature of the brazing foil is carried out in a continuous furnace.

31. A method of brazing two or more components of a heat exchanger or of an exhaust gas recirculation cooler comprising introducing a brazing foil according to claim 1.

32. A method for brazing two or more components made of an austenitic stainless steel or an Ni alloy or a Co alloy comprising introducing a brazing foil according to claim 1.
